(19) United States
(12) Patent Application Publication
(10) Pub. No.: US 2015/0035472 A1
(43) Pub. Date: Feb. 5, 2015

(54) REEL TYPE POWER BANK

(71) Applicant: SAMYA TECHNOLOGY CO., LTD., TAOYUAN COUNTY (TW)

(72) Inventor: FU-I YANG, TAOYUAN COUNTY (TW)

(73) Assignee: SAMYA TECHNOLOGY CO., LTD., TAOYUAN COUNTY (TW)

(21) Appl. No.: 13/958,755

(22) Filed: Aug. 5, 2013

(51) Int. Cl. H02J 7/00

(52) U.S. Cl. CPC H02J 7/0042
USPC 320/103

(57) ABSTRACT

A reel type power bank includes a predetermined shaped housing with an accommodating space, at least one rechargeable battery installed on a side of the accommodating space, a control circuit board electrically coupled to rechargeable battery and having a DC-to-DC power conversion circuit for regulating an output voltage of the rechargeable battery, a USB output interface coupled to DC-to-DC power conversion circuit, and a reel built in the housing, and installed on a side of the control circuit board, and including a winder and a charging cable wound around the winder. The charging cable has an outer end coupled to a USB plug and an inner end extended from the winder and out of the storage case, and electrically coupled to the DC-to-DC power conversion circuit, such that the charging cable can be pulled out for use or wound and hidden into the housing of the power bank.

### BACKGROUND OF THE INVENTION

1. Field of the Invention

The present invention relates to a reel type power bank, in particular to the power bank having a built-in reel and a charging cable hidden in the reel and users can pull out the hidden micro USB charging cable from the reel to charge an electronic product.

2. Description of the Related Art

In various different types of portable electronic products such as mobile phones, MP3 players, personal digital assistants (PDA), notebook computers, electronic dictionaries, and digital cameras, battery is one of the necessary equipments. However, the aforementioned electronic products will become useless if the power of the battery is exhausted and a charging power supply is unavailable, particularly when a user carries the electronic products out, thus causing tremendous inconvenience to the user.

Therefore, a portable power bank has been introduced to the market, and such small-size power bank is stored with backup power, so that users do not have to worry about running out of battery in anywhere. Obviously, the power bank is convenient.

However, the conventional power bank charges an electronic product mainly in the following two methods: One method is to use a USB charging cable to connect the electronic product for charging, but this method cannot be used if users forget to carry the charging cable with them, and this method has a storage issue even if the users remember to carry the cable with them. The other method is to provide a small section of the USB charging cable 51 connected to the power bank 50 as shown in FIG. 1, such that the cable 51 can be folded and stored on the surface of a housing of the power bank 50. When use, the USB charging cable 51 is lifted to charge the electronic product 52. This type of products has been disclosed in R.O.C. Utility Model No. 151460. Although the charging cable 51 and the power bank 50 are connected with each other in accordance with this method and it can overcome the problem that the users may forget to bring the cable with them, yet there is only a short section (with a length of several centimeters only) of the USB charging cable 51, so that when the electronic product 52 is charged, the power bank 50 is situated next to the electronic product 52, and users are unable to operate the electronic product 52 normally or conveniently. Obviously, the use is very inconvenient.

In view of the aforementioned problems, the inventor of the present invention conducted researches and experiments and developed a reel type power bank to overcome the problems of the prior art.

### SUMMARY OF THE INVENTION

It is a primary objective of the present invention to overcome the aforementioned problem of the prior art by providing a reel type power bank in accordance with the present invention.

To achieve the aforementioned objective, the present invention provides a reel type power bank with a built-in reel of a charging cable, such that the charging cable can be pulled out directly from the reel and connected to an electronic product for charging the electronic product without requiring users to carry an additional charging cable, so as to overcome the problem of charging inconveniently by the conventional power bank, and achieve the effect of providing a convenient carry and a user-friendly use.

Another objective of the present invention is to provide a reel type power bank connected to a DC-to-DC power conversion circuit for regulating the discharge voltage of the rechargeable battery to 5V, and the invention can satisfy the requirement of a compact power bank to provide a convenient carry.

To achieve the aforementioned objective, the present invention provides a reel type power bank, comprising: a housing, being a determined shaped body, and having an accommodating space therein; at least one rechargeable battery, installed on a side of the accommodating space; a control circuit board, installed in the housing and at an end corner opposite to the other side of the rechargeable battery, and having an inner side electrically coupled to the rechargeable battery, and further comprising: a charging input interface, coupled to the control circuit board, for inputting a charging power; a switch, coupled to the charging input interface, and electrically coupled to the rechargeable battery; a micro control unit (MCU), coupled to the switch; a constant voltage/constant current circuit, coupled to the MCU; a direct current to direct current (DC-to-DC) power conversion circuit, coupled to the constant voltage/constant current circuit and the switch; a universal serial bus (USB) output interface, coupled to the DC-to-DC power conversion circuit, and having a portion exposed from a surface of the housing, for outputting electric power; and a reel, built in the housing, and installed on a side of the control circuit board, and including a storage case, a winder disposed in the storage case, and a charging cable wound around the winder, and an outer end of the charging cable being extended from a notch formed at the periphery of the storage case and coupled to a USB plug, and an inner end of the charging cable being extended from the winder and out of the storage case, and electrically coupled to the DC-to-DC power conversion circuit, and the winder being rotatable clockwise or counterclockwise in the storage case, such that the charging cable can be pulled out for use or wound and hidden into the housing of the power bank.

Wherein, the MCU of the control circuit board is further coupled to an electricity capacity display interface, and the electricity capacity display interface is comprised of a plurality of light emitting diodes (LEDs), and a portion of the electricity capacity display interface is exposed from a surface of the housing.

In a preferred embodiment, the housing includes a groove formed on a side of the reel for accommodating the USB plug when the charging cable is wound.

With the aforementioned technical characteristics, the power bank of the present invention can regulate the discharge voltage of the rechargeable battery to 5V and satisfy the requirement of a compact power bank. In addition, the built-in reel of a charging cable can store a Micro USB charging cable of over 30 cm, so that users can pull out the charging cable from the reel directly and connected to an electronic product for charging the electronic product without the need of carrying the charging cable. Therefore, the invention can overcome the problems of charging inconveniently by the conventional power bank, and achieve the effect of providing a convenient carry and a user friendly use.

### BRIEF DESCRIPTION OF THE DRAWINGS

FIG. 1 is a schematic view of charging a conventional power bank;

FIG. 2A is a perspective view of winding a charging cable in accordance with a preferred embodiment of the present invention;

FIG. 2B is a schematic view of pulling out a charging cable in accordance with a preferred embodiment of the present invention;

FIG. 3 is a top view of a preferred embodiment of the present invention;

FIG. 4 is a side view of a preferred embodiment of the present invention;

FIG. 5 is a schematic view of a preferred embodiment of the present invention;

FIG. 6 is a circuit diagram of a preferred embodiment of the present invention; and

FIG. 7 is a schematic view of a using status of the present invention.

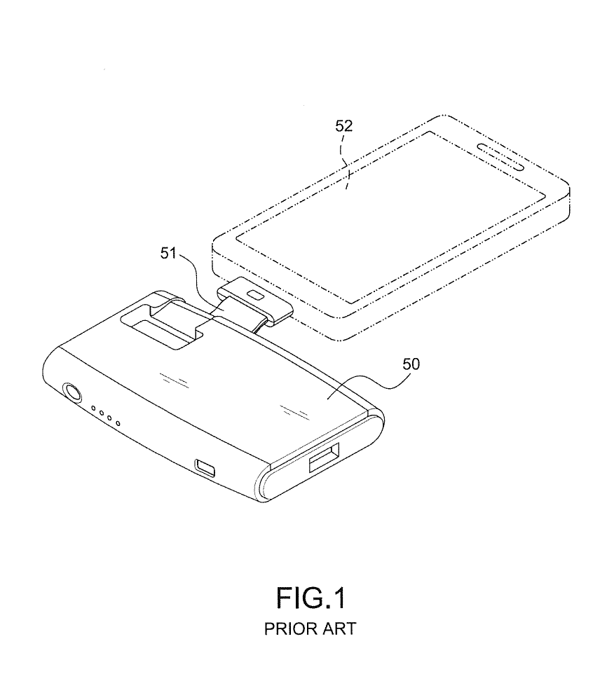

### DETAILED DESCRIPTION OF THE PREFERRED EMBODIMENT

The present invention will become clearer in light of the following detailed description of an illustrative embodiment of this invention described in connection with the drawings. It is intended that the embodiments and drawings disclosed herein are to be considered illustrative rather than restrictive.

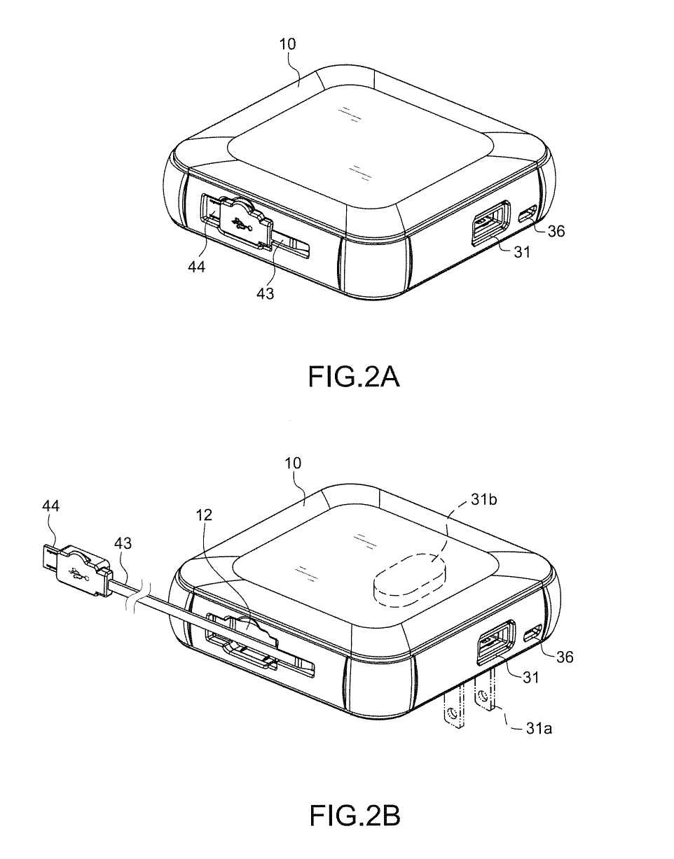

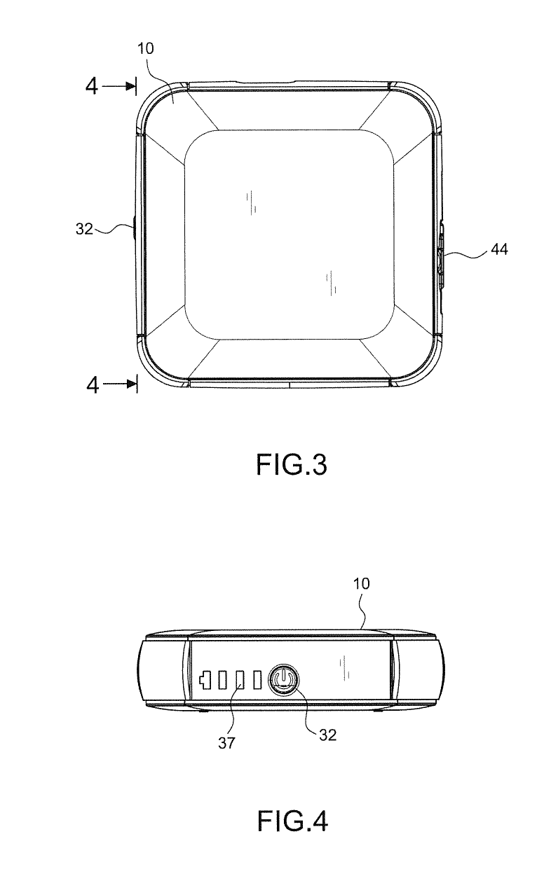

With reference to FIGS. 2 to 6 for a reel type power bank in accordance with a preferred embodiment of the present invention, the reel type power bank comprises a housing 10 which is a predetermined shaped body and has an accommodating space 11 therein, and the housing 10 of this preferred embodiment is a cube with a length of 83 mm, a width of 83 mm and a thickness of 23 mm for a convenient carry. However, the housing 10 is not limited to the aforementioned arrangement only. The present invention further comprises a reel 40 built in the limited space of the housing 10 to achieve the power bank with the reel 40.

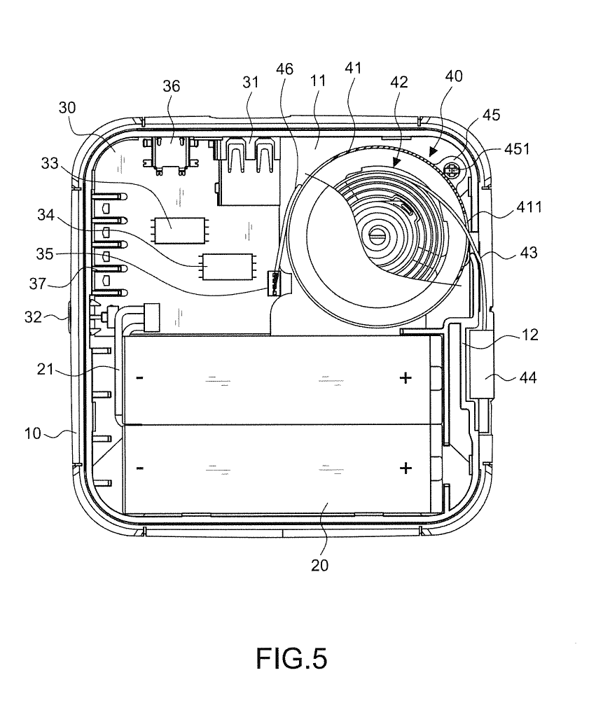

With reference to FIG. 5 for a cross-sectional top view of an opened housing 10 of the present invention, at least one rechargeable battery 20 is installed on a side of the accommodating space 11, and the rechargeable battery 20 includes a lithium battery, a nickel-metal hydride battery, etc, and a control circuit board 30 is installed in the housing 10 and disposed at an end corner opposite to the other side of the rechargeable battery 20, and an inner side of the control circuit board 30 is electrically coupled to the rechargeable battery 20 by a cable 21.

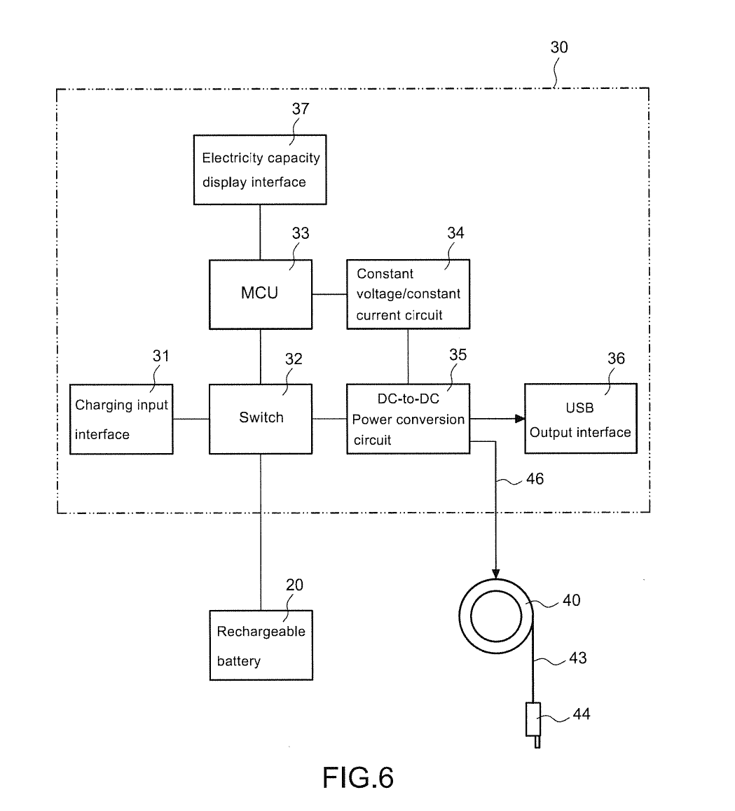

In FIG. 6, the control circuit board 30 comprises the following components. A charging input interface 31 is coupled to the control circuit board 30 for inputting a charging power. In this preferred embodiment, the charging input interface 31 is a USB connector 31 exposed from a side of the housing 10 as shown in FIG. 2B. However, the charging input interface 31 of the invention is not limited to such arrangement only, but it also can be a foldable plug 31a installed at the bottom of the housing 10 that can be plugged to a socket directly and provided for charging an electronic product, or a coil 31b installed in the housing 10 and provided for performing a wireless charging of the electronic product. However, the assembly of the aforementioned charging input interface is a prior art, and thus will not be described in detail.

A switch 32 is coupled to the charging input interface 31 and electrically coupled to the rechargeable battery 20 for controlling a charge/discharge of the rechargeable battery 20.

A MCU 33 is coupled to the switch 32; a constant voltage/constant current circuit 34 is coupled to the MCU 33; a DC-to-DC power conversion circuit 35 is coupled to the constant voltage/constant current circuit 34 and the switch 32; a USB output interface 36 is coupled to the DC-to-DC power conversion circuit 35 and has a portion exposed from a surface of the housing 10 for outputting power.

In FIG. 4, the MCU 33 of the control circuit board 30 of this preferred embodiment is further coupled to an electricity capacity display interface 37, and the electricity capacity display interface 37 is comprised of a plurality of LEDs, and a portion of the electricity capacity display interface 37 is exposed from a surface of the housing 10.

Wherein, the DC-to-DC power conversion circuit 35 is provided for regulating an output voltage of the rechargeable battery 20, and the DC-to-DC power conversion circuit 35 of this preferred embodiment regulates the output voltage of the rechargeable battery 20 to 5V to supply the basic required DC voltage to the power bank. However, the output voltage of the rechargeable battery 20 of the invention is not limited to 5VDC voltage only.

In FIG. 5, the reel 40 of a preferred embodiment is built in the housing 10 and installed on a side of the control circuit board 30, and the reel 40 comprises a storage case 41 and a winder 42 installed in the storage case 41 and a charging cable 43 wound around the winder 42, and an outer end of the charging cable 43 is extended out from a notch 411 at the periphery of the storage case 41 and connected to a USB plug 44, and an inner end of the charging cable 43 is passed through the winder 42 to form a cable 46 extended out of the storage case 41. In addition, a positioning lug 45 is formed at the external periphery of the storage case 41 of the reel 40 for fixing a positioning element 451 into the housing 10.

Since the principle of winding the cable by the winder 42 is used which is a prior art and has been used in a reel of a mouse already, therefore the internal structure will not be described in detail. The present invention primarily applies the winding function of the winder and builds the reel 40 on a side of the control circuit board 30 within the limited space of the housing 10, and further extends the cable 46 from the winder 42 and out of the storage case 41, and the cable 46 is electrically coupled to the DC-to-DC power conversion circuit 35, so that the USB plug 44 at an outer end of the charging cable 43 can output power to charge an electronic product.

In addition, the storage case 41 is fixed in the housing 10, and the winder 42 can be rotated clockwise or counterclockwise in the storage case 41, such that the charging cable 43 can be pulled out for use or wound into the housing 10 of the power bank for storage. In a preferred embodiment, a latch (not shown in the figure) is disposed at the periphery of the winder 42, so that when the charging cable 43 is pulled or rewound, the latch will be latched automatically, and the charging cable 43 can be loosened by pulling the latch again, or the charging cable 43 can be rewound by pressing the latch again. However, the aforementioned winding/rewinding assembly and function are prior arts, and thus the latch inside the reel 40 will not be described in detail.

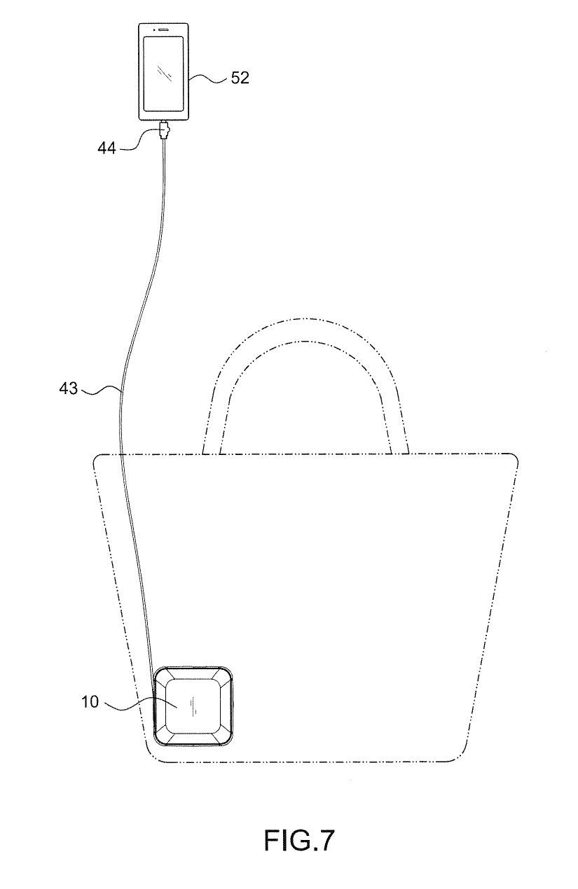

In this preferred embodiment, the reel 40 has an external diameter of approximately 4 cm. Since the Micro USB charging cable 43 is in a small and thin shape, therefore at least 30 cm of the Micro USB charging cable 43 can be wound. With reference to FIG. 7 for a schematic view of a using status of the present invention, a user can put the housing 10 of the power bank into a pocket, a backpack or a purse and pull out the charging cable 43 hidden in the reel 40 to charge the electronic product 52. Obviously, the invention is convenient and user-friendly.

In FIGS. 2A and 2B, the housing 10 of a preferred embodiment is installed on a side of the reel 40 and has a groove 12 for accommodating the USB plug 44 when the charging cable 43 is wound.

In summation of the description above, the present invention has the following advantages:

1. The power bank of the present invention has the reel 40 built in the charging cable 43 and capable of storing a Micro USB charging cable 43 over 30 cm. The cable 43 can be pulled out directly for charging an electronic product without the need of carrying an additional charging cable. Therefore, the invention can overcome the problem of charging inconveniently by the conventional power bank, and achieve the effect of providing a convenient carry and a user-friendly use.

2. The power bank of the present invention is combined with the DC-to-DC power conversion circuit 35 to regulate the discharge voltage of the rechargeable battery 20 to 5V and satisfy the requirement of a compact power bank to provide users a convenient carry.

What is claimed is:

1. A reel type power bank, comprising:
a housing, being a determined-shaped body, and having an accommodating space therein;
at least one rechargeable battery, installed on a side of the accommodating space;
a control circuit board, installed in the housing and at an end corner opposite to the other side of the rechargeable battery, and having an inner side electrically coupled to the rechargeable battery, and further comprising:
a charging input interface, coupled to the control circuit board, for inputting a charging power;
a switch, coupled to the charging input interface, and electrically coupled to the rechargeable battery;
a micro control unit (MCU), coupled to the switch;
a constant voltage/constant current circuit, coupled to the MCU;
a direct current to direct current (DC-to-DC) power conversion circuit, coupled to the constant voltage/constant current circuit and the switch;
a universal serial bus (USB) output interface, coupled to the DC-to-DC power conversion circuit, and having a portion exposed from a surface of the housing, for outputting electric power; and
a reel, built in the housing, and installed on a side of the control circuit board, and including a storage case, a winder disposed in the storage case, and a charging cable wound around the winder, and an outer end of the charging cable being extended from a notch formed at the periphery of the storage case and coupled to a USB plug, and an inner end of the charging cable being extended from the winder and out of the storage case, and electrically coupled to the DC-to-DC power conversion circuit, and the winder being rotatable clockwise or counterclockwise in the storage case, such that the charging cable can be pulled out for use or wound and hidden into the housing of the power bank.

2. The reel type power bank of claim 1, wherein the MCU of the control circuit board is further coupled to an electricity capacity display interface, and the electricity capacity display interface is comprised of a plurality of light emitting diodes (LEDs), and a portion of the electricity capacity display interface is exposed from a surface of the housing.

3. The reel type power bank of claim 1, wherein the housing includes a groove formed on a side of the reel for accommodating the USB plug when the charging cable is wound.

4. The reel type power bank of claim 1, wherein the chargeable battery includes a lithium battery and a nickel-metal hydride battery.

5. The reel type power bank of claim 1, wherein the reel has a positioning lug disposed at the external periphery of the storage case and provided for fixing a positioning element in the housing.

6. The reel type power bank of claim 1, wherein the charging input interface is a USB connecting base exposed from a side of the housing.

7. The reel type power bank of claim 1, wherein the charging input interface is a foldable plug installed at the bottom of the housing.

8. The reel type power bank of claim 1, wherein the charging input interface is a coil installed in the housing for performing wireless charging.
